(19) United States
(12) Patent Application Publication
(10) Pub. No.: US 2008/0135004 A1
(43) Pub. Date: Jun. 12, 2008

(54) Timing Phaser Control System

(75) Inventors: Roger T. Simpson, Ithaca, NY (US); Franklin R. Smith, Cortland, NY (US)

Correspondence Address: BORGWARNER INC.;c/o Brown & Michaels, PC, 400 M&T Bank Building, 118 N. Tioga Street, Ithaca, NY, 14850, US

(73) Assignee: BORGWARNER INC., Auburn Hills, MI (US)

(21) Appl. No.: 11/817,043

(22) PCT Filed: May 2, 2006
(86) PCT No.: PCT/US2006/017259

§ 371 Date: Aug. 24, 2007

Related U.S. Application Data
(60) Provisional application No. 60/676,771, filed on May 2, 2005.

(51) Int. Cl. F01L 1/344; F02D 13/02

(52) U.S. Cl. 123/90.17; 92/120; 701/102

(57) ABSTRACT

A phaser (22) includes a housing (44), a rotor (42), a phaser control valve (36) and a regulated pressure control system (RPCS). The phaser control valve (36) directs fluid to shift the relative angular position of the rotor relative to the housing (44). The RPCS has a controller, which provides a set point based on engine parameters. A signal is then produced based on the set point and is sent to the direct control pressure regulator valve. (38) The direct control pressure regulator valve (38) has a supply port (5) and a control port (5), where the supply port (5) receives a supply fluid pressure from a source and regulates the pressure based on a signal, to a control pressure. The control pressure biases an end of the spool of the phase control valve (36) against a spring (66), such that the relative angular position of the housing (44) and the rotor (42) is shifted. A method of controlling a phaser (22) is also disclosed.

### REFERENCE TO RELATED APPLICATIONS

This application claims an invention which was disclosed in Provisional Application No. 60/676,771, filed May 2, 2005, entitled “TIMING PHASER CONTROL SYSTEM”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of control systems for variable cam timing systems. More particularly, the invention pertains to a variable cam timing phaser with a regulated pressure control system (RPCS).

2. Description of Related Art

Internal combustion engines have employed various mechanisms to vary the angle between the camshaft and the crankshaft for improved engine performance or reduced emissions. The majority of these variable camshaft timing (VCT) mechanisms use one or more “vane phasers” on the engine camshaft (or camshafts, in a multiple-camshaft engine). In most cases, the phasers have a housing with one or more vanes, mounted to the end of the camshaft, surrounded by a housing with the vane chambers into which the vanes fit. It is possible to have the vanes mounted to the housing, and the chambers in the housing, as well. The housing's outer circumference forms the sprocket, pulley or gear accepting drive force through a chain, belt or gears, usually from the camshaft, or possibly from another camshaft in a multiple-cam engine.

In some systems, the spool valve of the phaser is controlled using pulse-width-modulation (PWM) to apply a percentage of the engine oil pressure to one end of the spool valve, opposing a spring force on the other side of the spool valve. Referring to prior art FIG. 1, a spool 200 is slidably housed within a cylindrical member 298 of the camshaft 226. The spool 200 includes a first land 200b, a second land 200a, and reduced diameter portion 200c between the lands 200a, 200b. The spool 200 is biased to the right in the figure by spring 202 contacting the end of the first land 200b. The spool 200 is biased to the left in the figure by a supply of pressurized hydraulic fluid within a portion 298a of the cylindrical member 298 on the outside of land 200a. The movement of the spool 200 to the right is limited by a sleeve-like mechanical stop 298b. The pressure within the portion 298b is controlled by a pressure control signal from a pulse width modulated (PWM) valve 206, which is controlled by the ECU 208. The PWM valve 206 receives engine oil from the main oil gallery through inlet line 210 and selectively delivers engine oil to portion 298a through line 212. Spent oil from the PWM valve 206 is returned by way of an outlet line 214 to a low pressure regulator valve 216, which also receives oil from inlet line 210. Oil from the low pressure regulator valve 216 is returned to the engine oil sump by outlet line 218. The low pressure regulator valve 216 serves to maintain a minimum oil pressure in the portion 298a of the cylindrical portion 298. The spool directs fluid to and from cylinders 254, 256 from lines 282, 294, 296 and check valve 284. Since the engine oil pressure naturally varies with engine speed, such techniques do not allow exact control over the spool valve position, since any PWM set-point can result in a different pressure on the spool valve, depending on the fluctuations in engine oil pressure.

To alleviate this problem, the prior art utilized other systems including differential pressure control systems. In this system, the engine oil pressure is pulse-width modulated to create a fractional pressure. This fractional pressure is still applied to a first end of the spool valve with one diameter of the valve, opposing a spring force on a second end of the spool valve with a smaller diameter. Since the same fractional pressure is applied to the large area as the small area, the opposing pressure on the second end is a fixed percentage, usually two times, the fractional pressure on the first end of the spool valve.

Referring to FIG. 2, spool valve 492 includes a spool 500 with an extension 500c, a first land 500b, and a second land 500a, a first spring 504, and a second spring 502. The spool 500 is housed within a cylindrical member 498 of the camshaft 426. The position of the spool 500 is further influenced by a supply of pressurized hydraulic fluid within a portion 498a of the cylindrical member 498 on the outside of the second land 500a, which urges the spool 500 to the left. The portion 498a receives pressurized fluid from the main oil gallery 530. The control of the position of the spool within the cylindrical member 498 is in response to the hydraulic pressure within a control pressure cylinder 534, whose piston 534a bears against the extension of the spool 500c. The surface area of the piston 534a is greater than the surface area of the end of the spool 500, which is exposed to hydraulic pressure within the portion 498 and is preferably twice as great. The pressure within the cylinder 534 is controlled by a solenoid 506, preferably of the pulse width modulated type (PWM) in response to a control signal from the ECU 508. The solenoid 506 receives engine oil from the engine oil gallery 530 through an inlet line 504 and selectively delivers engine oil from the source to the cylinder through a supply line 538. The spool valve 492 directs fluid to and from recesses 432a, 432b formed between the vane and the housing from lines 488, 490, 496, 482, 494, 460c, and check valves 486, 484. Thus, this type of system uses differential pressure to remove variations in engine oil pressure, allowing more precise control over the spool valve position, albeit with more complex oil pathways and a more complicated spool valve.

Therefore, it is desirable to have a timing phaser control system which is accurate, resistant to engine oil fluctuations, and which utilizes a simple spool valve configuration.

### SUMMARY OF THE INVENTION

A phaser includes a housing, a rotor, a phaser control valve and a regulated pressure control system (RPCS). The RPCS has a controller which provides a set point, a desired angle and a signal based on engine parameters to a direct control pressure regulator valve. The direct control pressure regulator valve has a supply port and control port, where the supply port receives a supply fluid pressure from a source and regulates the pressure based on the signal, which is based on the set point, to a control pressure. The phaser control valve directs fluid to shift the relative angular position of the rotor relative to the housing. The phaser control valve has a spool with a first end and a second end slidable received in a bore of the rotor. The first end of the spool is biased by a spring a first direction. The control pressure biases the second end of the spool in a second direction opposite the first direction, such that the relative angular position of the housing and the rotor is shifted.

A method of controlling the positioning of the phaser is also disclosed. In a first step, the ECU or controller provides a set point and a desired angle between the camshaft and the crankshaft based on numerous engine parameters. Then the set point is summed with the actual phase position between the camshaft and the crankshaft, resulting in an error signal. The resulting error signal is entered into a control law and is converted to a control signal. The control signal is then summed with a null control signal. The summed signal is then sent to the regulated pressure control valve in the next step. Supply oil pressure from an oil gallery is also inputted into the regulated pressure control valve, resulting in a directly regulated output control oil pressure. The regulated control pressure from the previous step moves the position of the spool in proportion to the pressure supplied, which then in turn moves the VCT phaser with the aid of cam torque or oil pressure, altering the phase between the camshaft and the crankshaft. After the VCT phaser is moved, the phase position is measured again the steps listed above repeat.

A rotary actuator and method of controlling the positioning according to the present invention with the regulated pressure control system is also disclosed.

### BRIEF DESCRIPTION OF THE DRAWINGS

FIG. 1 shows a schematic of a prior art phaser using a pulse width modulated valve to control the position of the spool within the spool valve.

FIG. 2 shows a schematic of a prior art phaser using a differential pressure control system to control the position of the spool within the spool valve.

FIG. 3a shows a schematic of a cam torque actuated phaser in the null position with a control system of the present invention.

FIG. 3b shows a schematic of a cam torque actuated phaser moving towards the advance position with a control system of the present invention.

FIG. 3c shows a schematic of a cam torque actuated phaser moving towards the retard position with a control system of the present invention.

FIG. 4 shows a schematic of a cam torque actuated phaser in the null position of an alternate embodiment.

FIG. 5 shows a schematic of an oil pressure actuated phaser in the null position with a control system of the present invention.

FIG. 6 shows a schematic of a torsion assist phaser in the null position with a control system of the present invention.

FIG. 7 shows a flow diagram of the control system of the present invention.

FIG. 8 shows another flow diagram of the control system of the present invention with a variable cam timing phaser.

FIG. 9 shows a schematic of the variable cam timing system with the control system of the present invention.

FIG. 10 shows a graph of the supply pressure versus the control pressure when different currents are applied to the direct control pressure regulator valve.

FIG. 11 shows a graph of the supply pressure versus the control pressure when different currents are applied to a direct control pressure regulator valve of an alternate embodiment.

FIG. 12 shows a schematic of a rotary actuator with the control system of the present invention.

FIG. 13 shows a flow diagram of the control system of the present invention with a rotary actuator.

### DETAILED DESCRIPTION OF THE INVENTION

The regulated pressure control system (RPCS) of the present invention receives an a signal, based on a set point, that causes a regulated pressure control valve or a direct control pressure regulator (DCPR) valve to adjust an input oil pressure to a regulated control oil pressure that biases an end of a spool of a phase control valve, in proportion to the signal and the pressure in the main oil gallery. The other end of the spool of the phase control valve is preferably biased in the opposite direction by a spring.

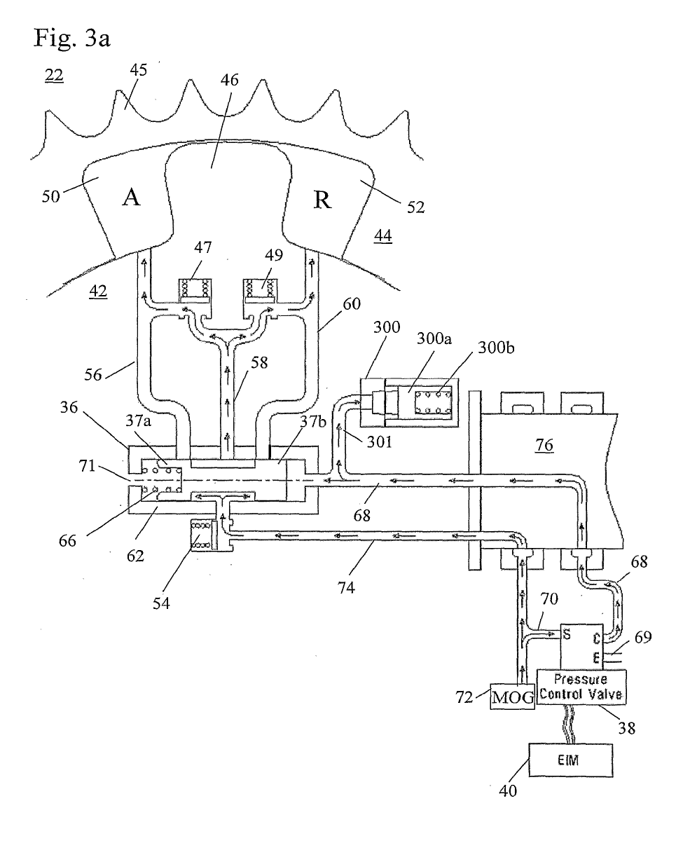

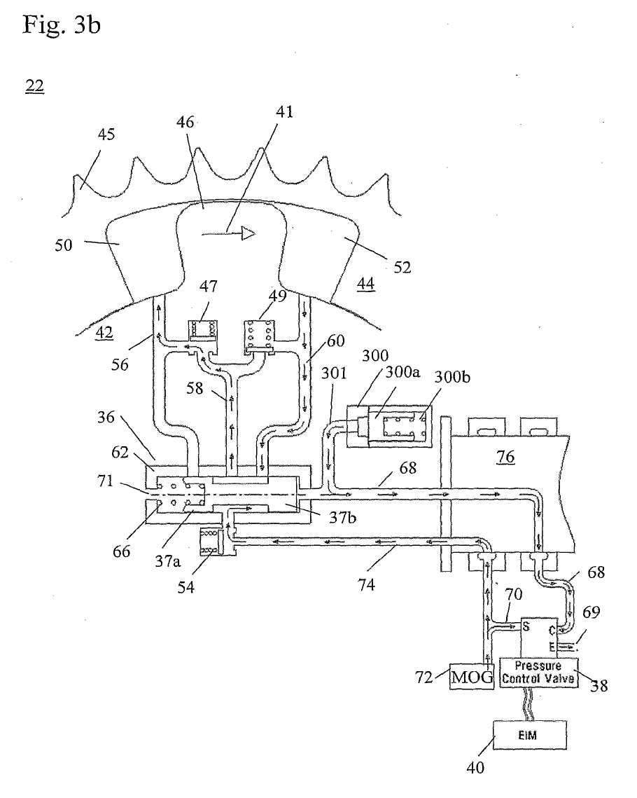

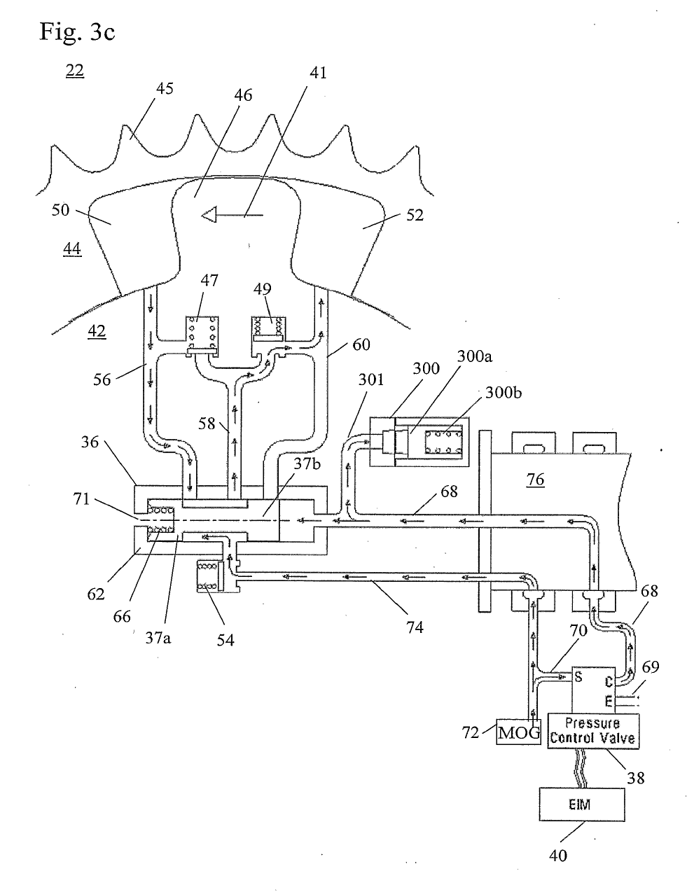

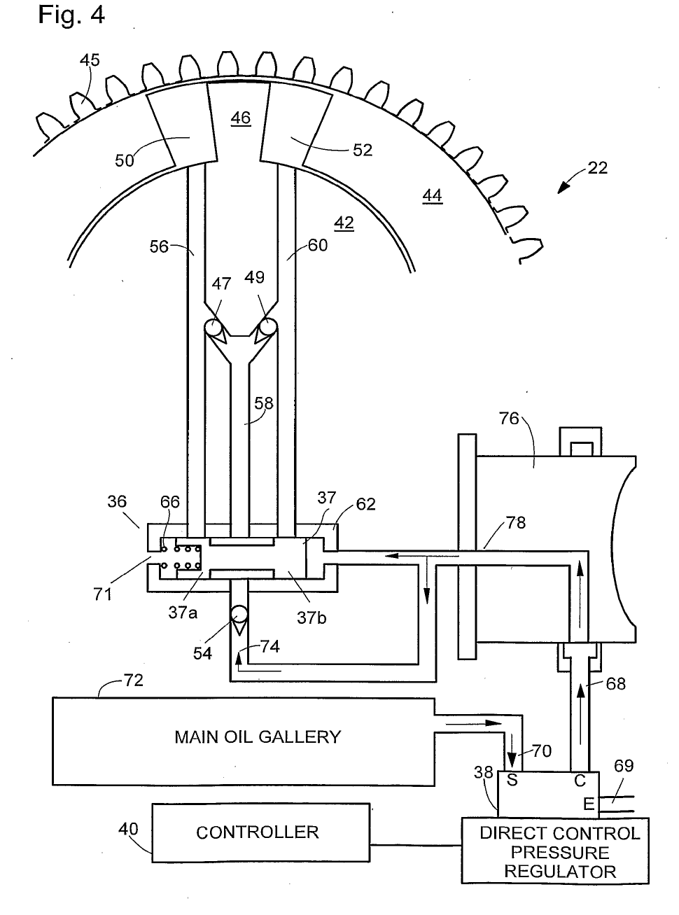

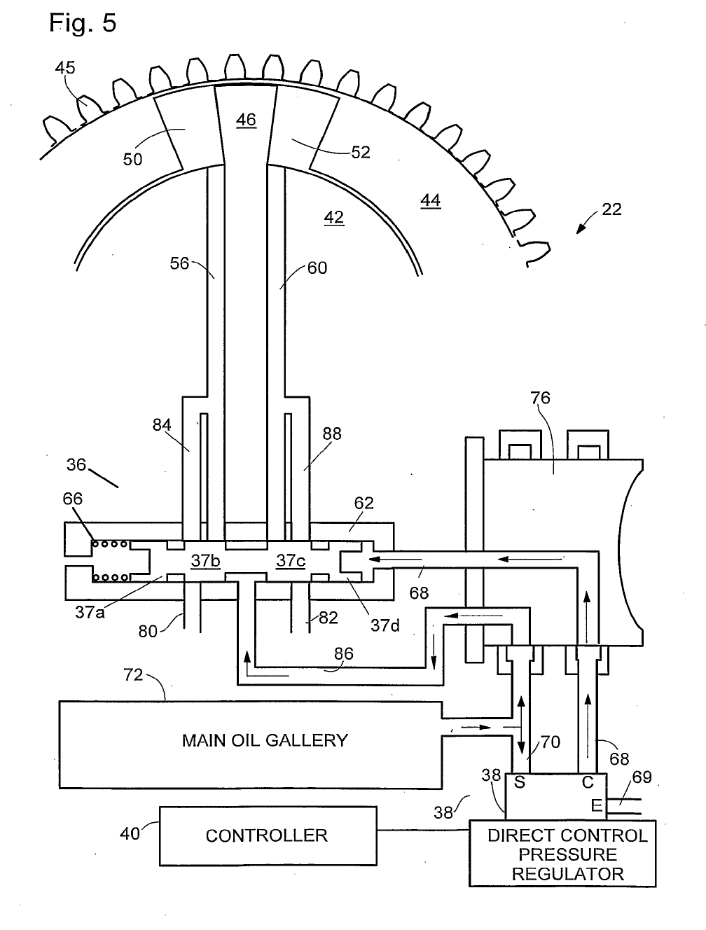

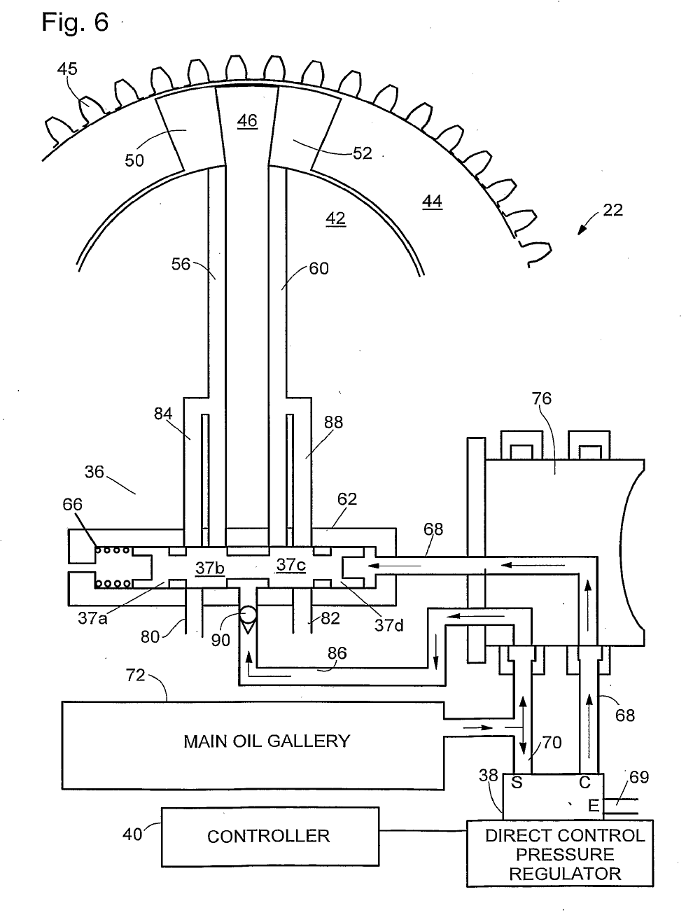

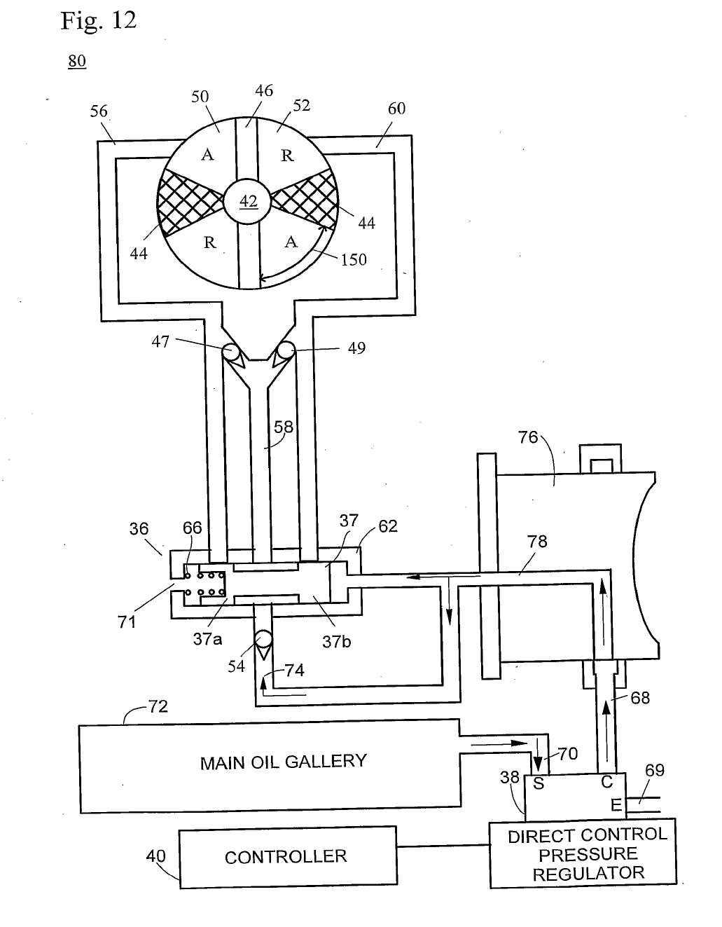

The regulated pressure control system may be used with a cam torque actuated phaser, as shown in FIGS. 3a through 3c and 4, an oil pressure actuated phaser, as shown in FIG. 5, a torsion assist phaser, as shown in FIG. 6, a rotary actuator as shown in FIG. 12, or a hybrid phaser as disclosed in application Ser. No. 11/286,483 entitled, “CTA PHASER WITH PROPORTIONAL OIL PRESSURE FOR ACTUATION AT ENGINE CONDITION WITH LOW CAM TORSIONALS,” filed on Nov. 23, 2005 and hereby incorporated by reference.

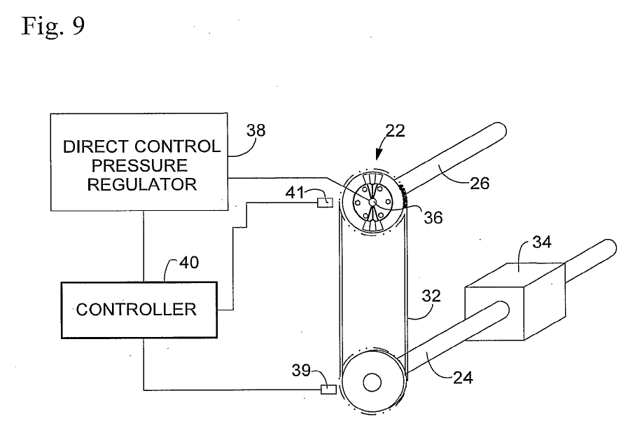

FIG. 9 shows the relationship between a camshaft 26, a crankshaft 24 and a phaser 22. A first rotatable body 24, preferably a crankshaft and a second rotatable body 26, preferably a camshaft are linked together by a mechanical coupling, which is preferably a chain, although the coupling may also be a belt or a pulley. The crankshaft 24 is coupled to and receives power from a power source 34, and drives the camshaft 26. The power source 34 may be one or more pistons from an engine, an electric motor, a crank, a turbine, or any other device capable of driving a shaft. A phaser 22 is coupled to the camshaft 26 and is capable of changing the relative angular position between the camshaft 26 and the crankshaft 24. The phaser has a spool valve 36 which is positioned by the direct control pressure regulator or the pressure control valve 38, which is coupled to a controller 40. Position sensors 39, 41 are coupled to the controller 40 and may be used to monitor the angular position of the camshaft 24 and the crankshaft 26.

FIGS. 3a through 3c show the control system of the present invention with a cam torque actuated phaser. Cam torque actuated (CTA) phasers use torque reversals in the camshaft, caused by the forces of opening and closing engine valves to move the vane. A control valve is present to allow fluid flow from chamber to chamber causing the vane to move, or to stop the flow of oil, locking the vane in position. The CTA phaser has oil input to make up for losses due to leakage, but does not use engine oil pressure to move the phaser. CTA phasers have shown that they provide fast response and low oil usage, reducing fuel consumption and emissions. However, in some engines, i.e. 4-cylinder engines, the torsional energy from the camshaft is not sufficient to actuate the phaser over the entire speed range of the engine, especially when the rpm is high and optimization of the performance of the phaser in view of engine operating conditions (e.g. the amount of available cam torque) is necessary.

Torque reversals in the camshaft caused by the forces of opening and closing engine valves move the cam torque actuated (CTA) vane 46. The advance and retard chambers 50, 52 are arranged to resist positive and negative torque pulses in the camshaft and are alternatively pressurized by the cam torque. The phase control valve, preferably a spool valve 36 allows the vane 46 in the phaser to move, by permitting fluid flow from the advance chamber 50 to the retard chamber 52 or vice versa, depending on the desired direction of movement, as shown in FIGS. 3b and 3c. Positive and negative cam torsionals are used to move the phaser.

The housing 44 of the phaser 22 has an outer circumference 45 for accepting drive force. The rotor 42 is connected to the camshaft and is coaxially located within the housing 44. The rotor 42 has at least one vane 46, which separates a chamber formed between the housing 44 and the rotor 42 into the advance chamber 50 and the retard chamber 52. The vane 46 is capable of rotation to shift the relative angular position of the housing 44 and the rotor 42.

The spool valve 36 includes a spool 37 with cylindrical lands 37a and 37b slidably received in a sleeve 62 in the rotor 42. The sleeve 62 has a first end which receives line 68 and a second end which has an opening or a vent 71 that leads to atmosphere. The position of the spool 37 is influenced by spring 66 and a direct control pressure regulator valve 38 of the regulated pressure control system, which is controlled by a controller or ECU 40. The position of the spool 37 controls the motion, (e.g. to move towards the advance position or the retard position) of the phaser and the position of the camshaft relative to the crankshaft.

The direct control pressure regulator valve 38 of the regulated pressure valve control system (RPCS) is located remotely from the phaser, preferably in the cylinder head or in the cam bearing cap 76 as shown, and receives an input or supply oil pressure from main oil gallery (MOG) 72 through line 70. The supply oil pressure from the main oil gallery 72 will typically vary with RPM, temperature, and engine load, but the direct control pressure regulator 38 is capable of supplying a steady known or constant control pressure proportional to a signal based on a set point from the controller 40. Controller 40 may be a microprocessor, application specific integrated circuit (ASIC), digital electronics, analog electronics, or any combination thereof. The control signal may be in current (amps), voltage (volts), or may be an encoded signal with digitized information. The direct control pressure regulator valve 38 also has an exhaust port E leading to line 69 and a control port C leading to line 68 through the cam bearing cap 76.

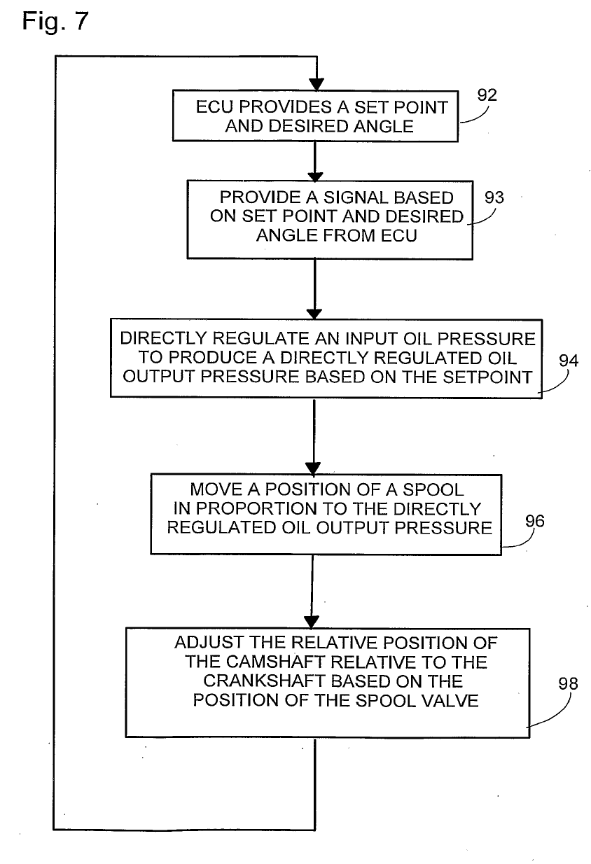

The direct control pressure regulator valve 38 receives supply pressure from the main oil gallery 72 through the supply port S and regulates it to a control pressure preferably between 0 to 15 PSI. The range of the control pressure is not limited to 0 to 15 PSI and may vary based on the application the system is being used with. The control pressure is proportional to the current of the valve. The current of the valve preferably ranges from 0 to 1 amp, but is not limited to this range and will vary based on the application. More specifically, as shown in FIG. 7, the controller or ECU 40 provides a set point and a desired angle between the camshaft and the crankshaft. Next a signal, based on the desired angle and the set point from the controller is provided in a second step 93. In a third step 94, the signal, based on the set point determined by the ECU aids in directly regulating a supply or input oil pressure, resulting in a controlled oil output pressure. The controlled oil output pressure is then routed to the phase control valve 36, biasing one side of the spool 37 against the spring 66 biasing the opposite side of the spool 37 in a fourth step 96. Lastly, the relative position of the camshaft 26 relative to the crankshaft 24 is adjusted based on the position of the spool of the phase control valve in the fifth step 98. The signal may also be an encoded signal containing digitized information.

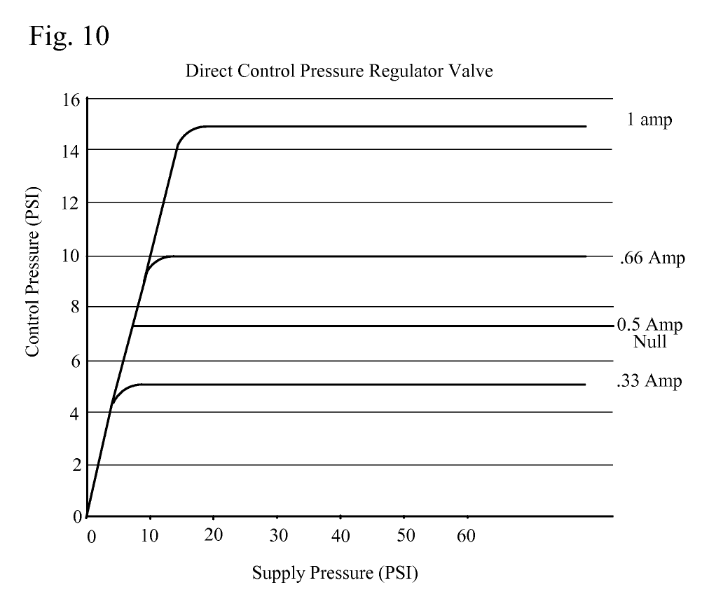

FIG. 10 shows a graph of the supply or input pressure in PSI versus the control pressure in PSI with application of the set point signal in amps applied to the direct control pressure regulator valve 38. Based on the supply pressure available and the signal, a control pressure results. The range of the signal may vary based on engine and design parameters. A null control signal, for example 0.5 amps results in setting the spool position to null and maintaining the position of the phaser, as long as the supply pressure provided is adequate. As an example in FIG. 10, the set point signal ranges from 0 to 1 amp. The resulting control pressure range may also vary based on engine and design parameters. In this example, the control pressure may range from 0 to 15 PSI (1 bar).

When the supply pressure is greater than or equal to 15 PSI, the control pressure that results is dependent on the strength of the signal. For example, if the signal is 0.33 amps, the control pressure would be 5 PSI; if the signal is 0.66 amps, the control pressure would be 10 PSI; and if the signal is 1 amp, the control pressure would be 15 PSI. If the supply pressure is less than 15 PSI, the control pressure is based on the strength of the signal and the available supply pressure. For example, if the signal was 0.33 amps and the supply pressure is 10 PSI, the control pressure is 5 PSI; and if the signal was 1 amp and the supply pressure is 10 PSI, the control pressure is 10 PSI. The control pressure can not be greater than the supply pressure available. By having the control pressure based on the signal and the supply pressure, the supply pressure is regulated to a constant. While 0.33 amps and 0.66 amps are shown, other signal strengths may also be used, but still allowing the spool to be moved to three positions, advanced, retard, and null.

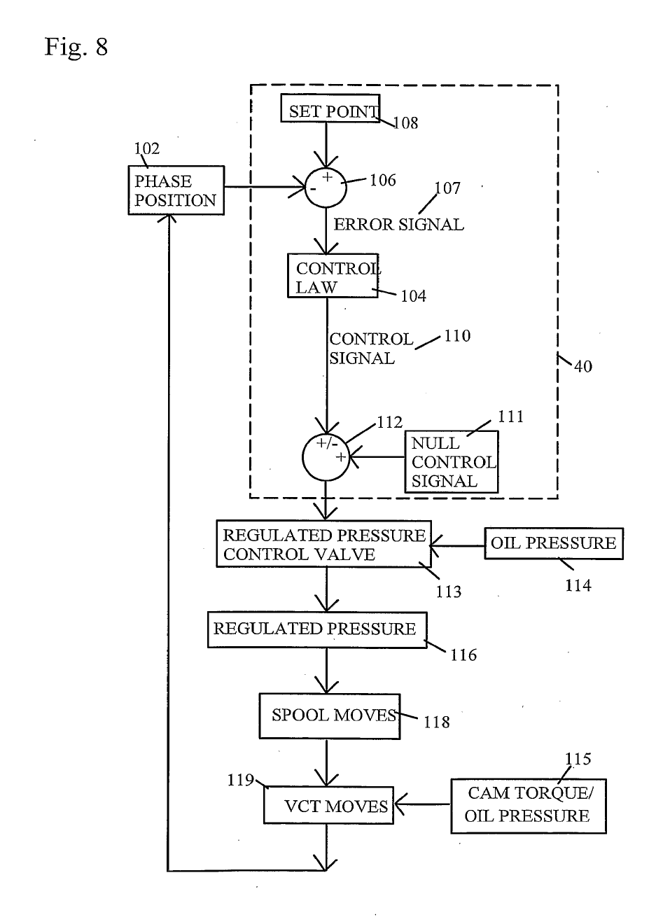

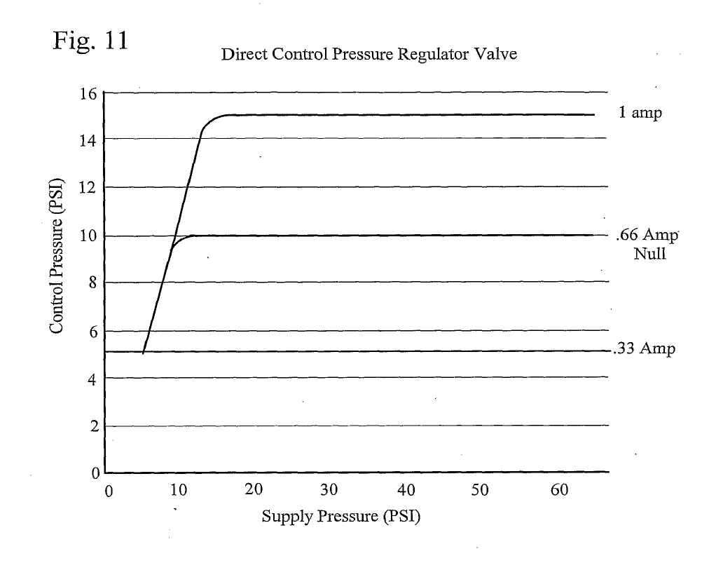

FIG. 8 schematically shows a more detailed closed loop control system of the regulated pressure control system of the present invention. In a first step 108, the ECU or controller 40 determines a desired angle between the camshaft 24 and the crankshaft 26 and a set point based on numerous engine parameters, such as but not limited to rpm, temperature, engine load, and throttle position. This set point is summed 106 with the actual phase position 102 between the camshaft 24 and the crankshaft 26 of the phaser 22. The resulting error signal 107, which may be positive, negative, or equal to zero, is entered into the control law 104. The control law 104 converts the error signal 107 to a control signal 110, which is either current or volts. The control signal 110 is summed 112 with a null control signal 111, which is also in volts or current and adjusts the position of the spool 37 to a null or middle position. As discussed in reference to FIG. 10, the null control signal is approximately 50% of the current over the range chosen. By summing 112 the null control signal 111 with the control signal 110, the spool 37 is moved back to a middle position, allowing the spool 37 to have the most amount of travel in either the advanced position or retard position as required in later steps to adjust the position of the phaser 22. The resulting summing signal in volts or current resulting from the sum 112 is sent to the regulated pressure control valve 38 in the next step 113. Supply oil pressure 114 from oil gallery 72 is also inputted into the regulated pressure control valve 38, resulting in a directly regulated output control oil pressure in step 116 as shown in FIGS. 10 and 11. The regulated control pressure from step 116 moves the position of the spool 37 in step 118 in proportion to the pressure supplied, which in turn moves the VCT phaser 22 with the aid of cam torque or oil pressure, altering the phase between the camshaft 24 and the crankshaft 26. After the VCT phaser 22 is moved in step 119, the phase position is measured again in step 102 and the steps listed above repeat.

It should be noted that the set point 108, the summing 106 of the set point 108 with the phase position 102, the resulting error signal 107, the control law 104, the resulting control signal 110, the null control signal 111, and the summing 112 of the control signal 110 with the null control signal 111 all takes place within the controller or ECU 40.

Steps 102-119 are similar to steps 92-98 discussed with regard to FIG. 7, and those discussions apply to steps 102-119 in FIG. 8 as well.

It should be noted that while a middle control pressure value of 10 PSI, as shown in FIG. 10 may be established, resulting in a spool position that leads to the phaser being in null position, the closed loop system will adjust the midpoint as necessary above or below the chosen midpoint within the range of pressure of the system as shown in FIG. 11.

Referring back to FIGS. 3a through 3c, the control pressure crosses the cam bearing 76 and the pressure creates a force on the second end of the spool 37 through line 68 against the spring 66 that biases the spool 37 in an opposite direction. The balance between the spring force and the control pressure 68 determines the spool position. By having the control pressure pass across the cam bearing cap interface 76, the leakage between the control fluid and the supply fluid is minimized by the tight cam bearing clearances and/or the cam bearing seals.

The direct control pressure regulator valve 38 may be, for example, a transmission pressure regulator valve. The direct control pressure regulator valve 38 may also be a direct acting variable force solenoid pressure regulator or a variable bleed pressure regulator. In the above example and embodiment, the direct control pressure regulator valve 38 was designed to output between 0-15 PSI when the main oil gallery pressure was 15 PSI or greater, although other control ranges may also be used.

In this embodiment, there are two oil passages provided through a cam bearing 76. The first is for the control pressure output 68, and the second is for the make-up oil input 74 from the main oil gallery. In the null or central position, as shown in FIG. 3a, the spool lands 37a and 37b of the spool valve block the flow of fluid, locking the vane in position. A small amount of fluid is provided to the phaser to make up for losses due to leakage.

In moving towards the advance position, as shown in FIG. 3b, the force of the control pressure from the direct control pressure regulator valve 38 in line 68 was reduced and the spool 37 was moved to the right in the figure by spring 66, until the force of spring 66 balanced the force of the control pressure from the direct control pressure regulator valve 38. In the position shown, the movement of the spool 37 forced fluid within the sleeve 62 to exit through line 68 to the control port C of the direct control pressure regulator valve 38. From the control port C, the fluid exhausts through the exhaust port to line 69. Spool land 37a blocks line 56; lines 58 and 60 are open, and the vane 46 can move towards the advance position. Camshaft torque pressurizes the retard chamber 52, causing fluid in the retard chamber 52 to move into the advance chamber 50 and the vane 46 to move in the direction indicated by arrow 41. Fluid exits the retard chamber 52 through line 60 to the spool valve 36 between spool lands 37a and 37b and recirculates back to central line 58, line 56, and the advance chamber 50.

Makeup oil is supplied to the phaser from the main oil gallery (MOG) 72 to make up for leakage and enters line 74 and moves through inlet check valve 54 to the spool valve 36. From the spool valve 36, fluid enters line 58 and through either of the check valves 47, 49, depending on which is open to the advance or retard chambers 50, 52.

In moving towards the retard position, as shown in FIG. 3c, the force of the control pressure from the RPCS system in line 68 was increased and the spool 37 was moved to the left by the pressure in line 68 from the regulated pressure control system 38, until the force of the spring 66 balances the force of the control pressure from the direct control pressure regulator valve 38.

In the position shown, the movement of the spool 37 forces any fluid in the sleeve 62 to exit through vent 71. Spool land 37b blocks line 60, lines 56 and 60 are open, and the vane 46 can move towards the retard position. Camshaft torque pressurizes the advance chamber 50 causing fluid in the advance chamber 50 to move into the retard chamber 52 and the vane 46 to move in the direction indicated by arrow 41. Fluid exits the advance chamber 52 through line 56 to the spool valve 36 between spool lands 37a and 37b, and recirculates back to line 58, line 60, and the retard chamber 52.

Makeup oil is supplied to the phaser from the main oil gallery (MOG) 72 to make up for leakage and enters line 74 and moves through inlet check valve 54 to the spool valve 36. From the spool valve 36, fluid enters line 58 and through either of the check valves 47, 49, depending on which is open to the advance or retard chambers 50, 52.

In a preferred embodiment, a locking pin 300 is slidably located in a radial bore in the rotor 42 comprising a body 300a having a diameter adapted for a fluid-tight fit in the radial bore. The locking pin 300 is biased to an unlocked position when the pressure of the fluid from line 301 is greater than the force of spring 300b. Line 301 is connected to line 68. The locking pin is locked when the pressure of the fluid in line 301 is less than the force of spring 300b biasing the body 300a of the locking pin. In moving toward the advance position, the pressure of fluid in line 301 is not greater than the force of the locking pin spring 300b, and the pin is moved to a locked position. In moving toward the retard position, and in the null position, the pressure of fluid in line 301 is greater than the force of the spring 300b and the locking pin is moved to an unlocked position.

FIG. 4 schematically illustrates another embodiment of a VCT phaser 22. The embodiment of FIG. 4 is identical to the embodiment of FIGS. 3a through 3c, except that the make-up oil for the cam torque activated system is supplied from the control pressure output 68 of the direct control pressure regulator valve 38, rather than from the main oil gallery 72. As a result, the phaser 22 is designed with only one oil passage 78 through the cam bearing 76. In this case, the pressure to the phaser 22 does not go below a predetermined minimum value, for example 0.35 bar or 5 psi, since this minimum pressure is needed to lubricate the cam bearing 76 and provide makeup oil to compensate for leakage. One way to maintain this minimum value is to design the direct control pressure regulator valve 38 so the minimum control pressure out is 5 psi, as shown in the graph of FIG. 11 of the supply or input pressure in PSI versus the control pressure in PSI with application of set point signals in amps applied to the direct control pressure regulator valve. In this embodiment, the control pressure ranges from 5 PSI to 15 PSI. Since a constant supply of pressure is available, even when a set point signal is not present, a small amount of oil may pass through the cam bearing, allowing one supply line. Alternatively, a dedicated separate oil path from the main oil gallery 72 to the cam bearing 76 could be provided for bearing lubrication.

It should be noted that while a middle control pressure value of 10 PSI, as shown in FIG. 11 may be established, resulting in a spool position that leads to the phaser being in the null position, the closed loop system will adjust the midpoint as necessary above or below the chosen midpoint.

FIG. 5 schematically illustrates an oil pressure activated phaser in the null position with the regulated pressure control system. In an oil pressure actuated system, the spool valve 36 having a spool 37 with lands 37a, 37b, 37c, and 37d selectively allows engine oil pressure from the main oil gallery 72 to either the advance chamber 50 or the retard chamber 52 via supply lines 56, 60, depending on the position of the spool valve 36. Oil from the opposing chamber is exhausted back through lines 84, 88 to the engine sump via either advance exhaust line 80 or retard exhaust line 82.

As in the embodiment shown in FIGS. 3a through 3c and further discussed with reference to FIGS. 7 through 11, the control oil pressure 68 from the direct control pressure regulator valve 38 is used to accurately position the spool 37 within the spool valve 36. One end of the spool 37 is biased in a direction by spring 66 and the control pressure from the direct control pressure regulator valve 38 biases the spool 37 in the opposite direction. Supply oil pressure 86, from the main oil gallery 72 is used to move the vane 46. As such, two oil passages go through the cam bearing 76, one for the control oil pressure 68 and one for oil from the main oil gallery 72 to be the supply oil pressure 86. In other oil-pressure activated embodiments, the supply oil pressure 86 may come solely from the control pressure 68, thereby making it possible to have only one oil passageway through the cam bearing 76.

FIG. 6 schematically illustrates a torsion assist phaser 22 with the regulated pressure control system of the present invention. The torsion assist phaser includes a check valve 90 in the oil supply line, or check valves in lines 56, 60 to each chamber (not shown). U.S. Pat. No. 6,883,481, issued Apr. 26, 2005, entitled “Torsional Assisted Multi-Position Cam Indexer Having Controls Located in Rotor” discloses a single check valve TA, and is herein incorporated by reference and U.S. Pat. No. 6,763,791, issued Jul. 20, 2004, entitled “Cam Phaser for Engines Having Two Check Valves in Rotor Between Chambers and Spool Valve” discloses two check valve TA, and is herein incorporated by reference. The check valve 90 blocks oil pressure pulses due to torque reversals, caused by changing load conditions, from propagating back into the oil system, preventing drainage of oil from the phaser when the engine is stopped, and stopping the vane from moving backwards due to torque reversals. Forward torque effects aid in moving the vane 46. Aside from the prevention of oil propagating back into the oil system from torque reversals, the torsion assisted phaser 22 operates in a similar fashion to the oil pressure activated system of FIG. 5

In a torsion assist phaser, the spool valve 36 selectively applies engine oil pressure from the main oil gallery 72 to either the advance chamber 50 or the retard chamber 52 via supply lines 56, 60, depending on the position of the spool valve 36. Oil from the opposing chamber is exhausted back through lines 84 and 88 to the engine sump via either advance exhaust line 80 or retard exhaust line 82. As in the embodiment shown in FIGS. 3a through 3c, and further discussed with reference to FIGS. 7 through 11, the control oil pressure 68 of the direct control pressure regulator valve 38 is used to accurately position the spool valve 36. The supply oil pressure 86, assisted by forward torque movements, is used to move the vane 46. The supply oil comes through the check valve 90 from the main oil gallery 72. As such, two oil passages go through the cam bearing, one for the regulated oil pressure 68 and one for oil from the main oil gallery 72 to be the supply oil pressure 86. Alternatively, the supply oil pressure 86 could come solely from the control pressure 68, thereby making it possible to have only one oil passageway through the cam bearing.

The regulated pressure control system or the direct control pressure regulator valve may also be used with a hybrid phaser, as disclosed in a patent application Ser. No. 11/286,483 entitled, “CTA PHASER WITH PROPORTIONAL OIL PRESSURE FOR ACTUATION AT ENGINE CONDITION WITH LOW CAM TORSIONALS,” filed on Nov. 23, 2005 and hereby incorporated by reference.

Additionally, the direct control pressure regulator valve 38 of the regulated pressure valve control system (RPCS) may be used with a rotary actuator, as shown in FIG. 12. In the rotary actuator 80, the housing 44 does not have an outer circumference for accepting drive force and motion of the housing is restricted. The housing is the stationary part. The restriction of the housing 44 ranges from not moving the housing at all to the housing having motion restricted to less than 360° as shown by arrow 150. All movement, other than the twisting of the shaft, is done by the rotor 42, which is the moving part. The rotor 42 and the vane 46 move or swing through the distance as defined and limited by the housing. All of the cyclic load is on the rotor 42 and the rotor 42 accepts all of the drive force. As in previous embodiments, the control oil pressure 68 from the direct control pressure regulator valve 38 is used to accurately position the spool valve. One end of the spool 37 is biased in a direction by spring 66 and the control pressure from the direct control pressure regulator valve biases the spool 37 in the opposite direction.

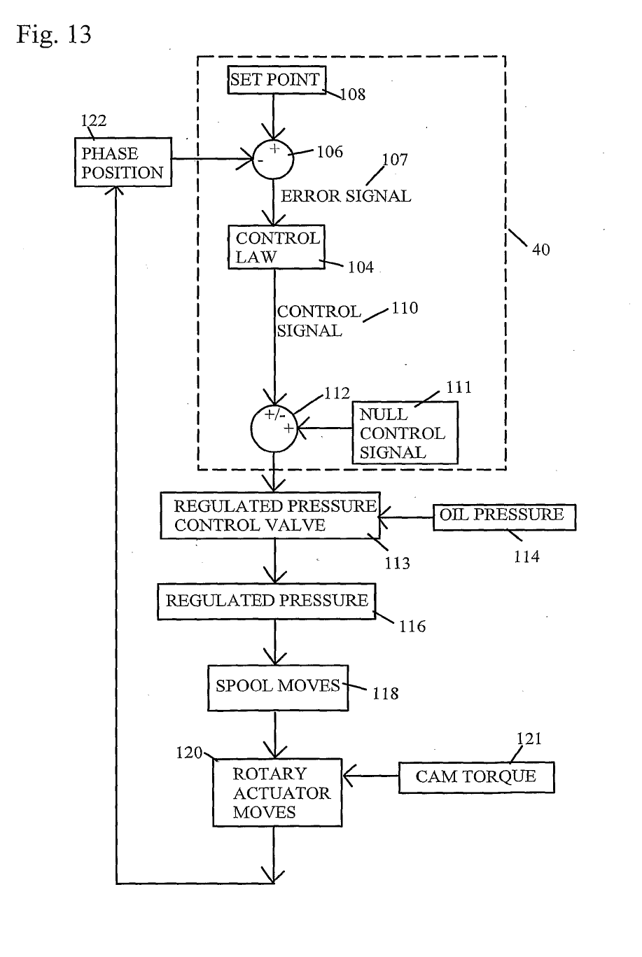

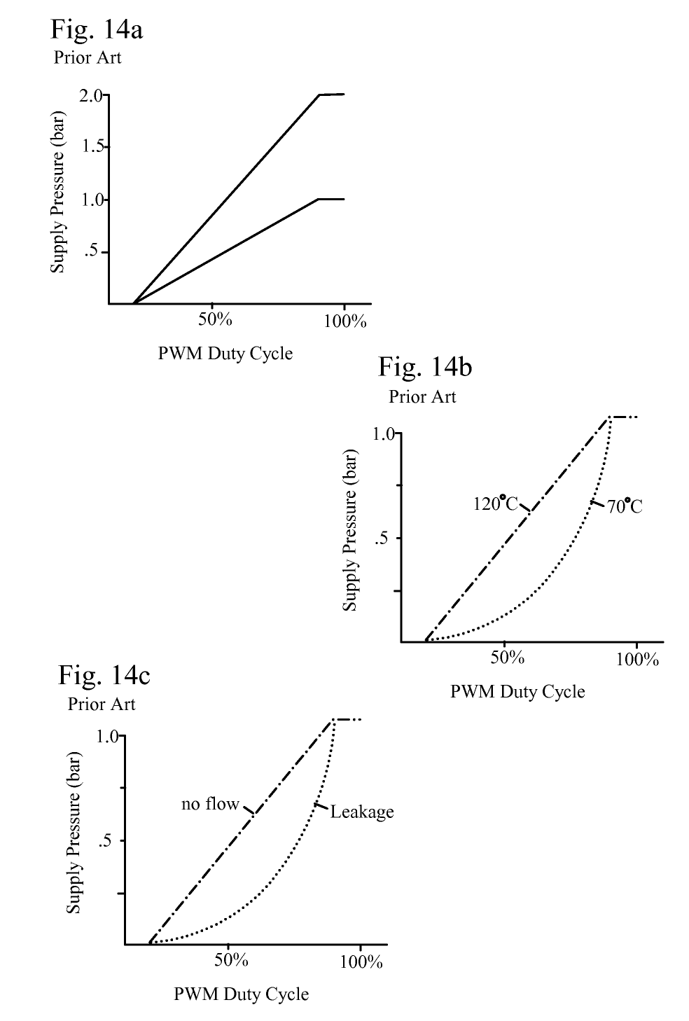

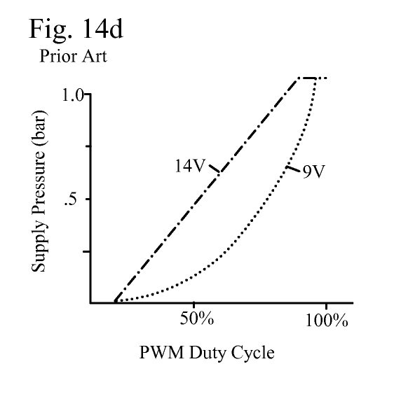

FIG. 13 schematically shows a more detailed closed loop control system of the regulated pressure control system of the present invention. In a first step 108, the ECU or controller 40 determines a desired angle between the camshaft and the crankshaft and a set point based on numerous engine parameters, such as but not limited to rpm, temperature, engine load, and throttle position. This set point is summed 106 with the actual phase position 102 between the stationary part or housing 44 and the moving part or the rotor 42. The resulting error signal 107, which may be positive, negative, or equal to zero, is entered into the control law 104. The control law 104 converts the error signal 107 to a control signal 110, which is either current or volts. The control signal 110 is summed 112 with a null control signal 111 which is also in volts or current and adjusts the position of the spool 37 to a null or middle position. As discussed in reference to FIG. 10, the null control signal is approximately 50% of the current over the range chosen. By summing 112 the null control signal 111 with the control signal 110, the spool 37 is moved back to a middle position, allowing the spool 37 to have the most amount of travel in either the advanced position or retard position as required in later steps to adjust the position of the rotary actuator 80. The resulting summing signal in volts or current resulting from the sum 112 is sent to the regulated pressure control valve 38 in the next step 113. Supply oil pressure 114 from oil gallery 72 is also inputted into the regulated pressure control valve 38, resulting in a directly regulated output control oil pressure in step 116 as shown in FIGS. 10 and 11. The regulated control pressure from step 116 moves the position of the spool 37 in step 118 in proportion to the pressure supplied, which in turn moves the rotary actuator 80 with the aid of cam torque 121, altering the phase between the housing or stationary part 44 and the rotor or moving part 42. After the rotary actuator 80 is moved in step 120, the phase position between the moving part and the stationary part is measured again in step 122 and the steps listed above repeat.

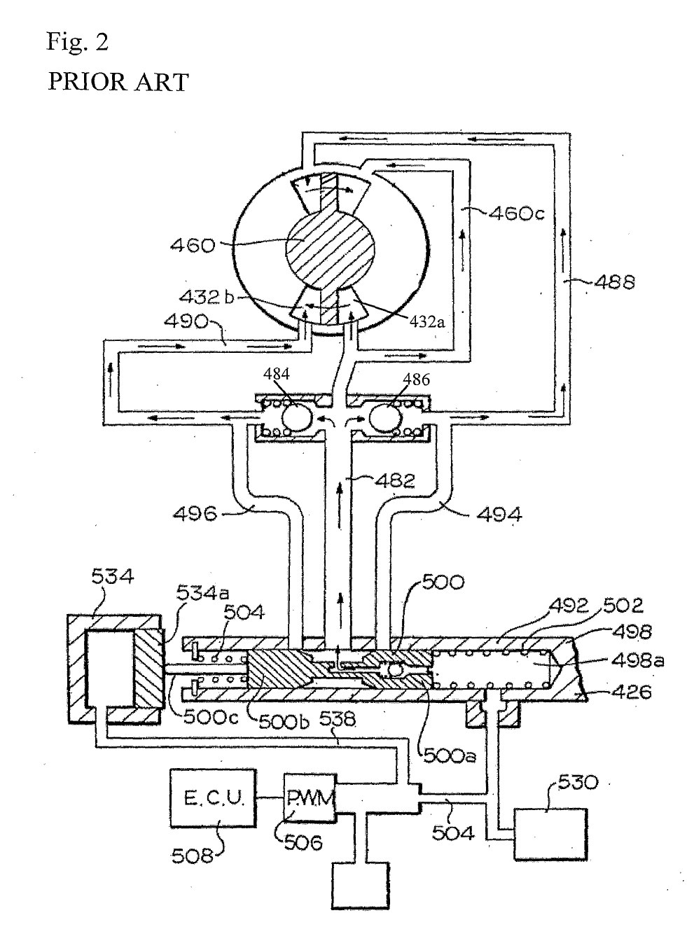

Many previous hydraulic control systems for phaser spool valves were designed to have the controlled oil pressure applied to both ends of the spool valve. For example in a differential pressure control system, as shown in prior art FIG. 2, a spool valve was required to have two diameters, a smaller diameter on the control end, and a larger diameter on the opposing end. The same pressure was applied to the larger area as applied to the smaller diameter, so since less force was applied to the side with the larger diameter, a spring was also present to bias the large diameter side of the spool. By having the same oil pressure applied to both ends of the spool valve, the fluctuations in oil pressure caused by variations in engine RPM were cancelled out. The current embodiments have a large advantage over such a differential pressure control system because the direct control pressure regulator eliminates or reduces unwanted pressure fluctuations to the point where a differential pressure system is not needed. This simplifies and reduces the cost of the spool valve, because the spool valve only has one diameter.

In addition to being less susceptible to changes in gallery pressure, the direct control pressure regulator valve 3 8 has a control pressure that does not have the high frequency pressure pulsation which is present in VCT systems which rely on pulse-width-modulation to adjust oil pressure. This allows for more exact control over the spool valve 36 position.

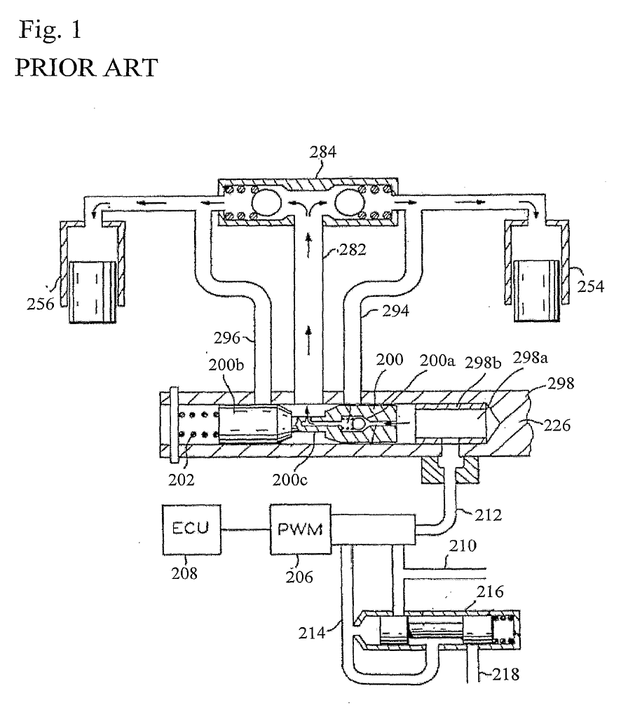

Another advantage is using only one control line to provide a set point to the direct control pressure regulator if desired, rather than multiple lines which are often necessary for pulse-width-modulation systems as shown in prior art FIG. 1. This allows a manufacturer who already has a controller with only one phaser control line, presumably for a variable force solenoid, to retrofit with or incorporate a hydraulically controlled spool valve without haying to redesign the controller. Furthermore, by using the regulated pressure valve control system, the overall axial package of the phaser is reduced.

The systems described herein, and their equivalents, reduce variation due to oil pressure fluctuations in the main oil gallery or supply pressure, essentially making the supply pressure a constant. The direct control pressure regulator may be mounted remote from the cam phaser. The direct control pressure regulator may also compensate for cam bearing leakage. The systems described herein may also maintain a cam phaser failsafe position, simplify the phaser design, and reduce the package length. The types of mechanical systems which can benefit from a timing phaser control system with a direct control pressure regulator are not limited to internal combustion engines. It is apparent that a variety of other functionally and/or structurally equivalent modifications and substitutions may be made to implement an embodiment for a timing phaser with a direct control pressure regulator according to the concepts covered herein, depending upon the particular implementation, while still falling within the scope of the claims below.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A variable cam timing phaser for an internal combustion engine having a crankshaft and at least one camshaft comprising:
a housing with an outer circumference for accepting drive force from the crankshaft;
a rotor for connection to a camshaft, coaxially located within the housing, having at least chamber between the housing and the rotor, and at least one vane separating the chamber into an advance chamber and a retard chamber, the at least one vane being capable of rotation to shift relative angular position of the housing and the rotor;
a phase control valve for directing fluid flow to shift the relative angular position of the rotor relative to the housing, having a spool slidably received in a bore, wherein the spool is biased by a spring in a first direction; and
a regulated pressure control system comprising:
a controller for providing a signal based on engine parameters; and
a direct control pressure regulator valve having control input coupled to the controller, a supply port for receiving a supply fluid source pressure from a pressurized fluid source and a control port for supplying a regulated control pressure to the bore at an opposite end to the spring, for biasing the spool in a second direction opposite to the first direction;
wherein the supply port of the direct control pressure regulator valve receives a supply fluid source pressure from a pressurized fluid source and the control pressure regulator valve regulates the supply fluid source regulated control pressure based on the signal from the controller to a control pressure, which exits the control pressure regulator valve through the control port to bias the second end of the spool in a second direction, opposite the first direction, such that the relative angular position of the housing and the rotor spool in the bore is shifted.

2. The phaser of claim 1, wherein the control pressure regulator valve is remote from the phaser.

3. The phaser of claim 1, wherein the control pressure regulator valve is located in a cylinder head of the internal combustion engine.

4. The phaser of claim 1, wherein the control pressure regulator valve is located in a cam bearing cap of the camshaft.

5. The phaser of claim 1, wherein the engine parameters upon which the signal is based are one or more of temperature, engine speed, and throttle position.

6. The phaser of claim 1, wherein the signal is a voltage proportional to a desired spool position.

7. The phaser of claim 1, wherein the signal is a current proportional to a desired spool position.

8. (canceled)

9. The phaser of claim 1, wherein the phase control valve controls phaser position by routing fluid from the pressurized fluid source to the advance chamber or the retard chamber, and routing fluid from the other of the retard chamber or advance retard chamber to an exhaust.

10. The phaser of claim 9, further comprising a check valve between the phase control valve and the pressurized fluid source.

11. The phaser of claim 1, wherein the phase control valve controls phaser position by selectively directing fluid from one of the advance chamber or the retard chamber to the other of the retard chamber or the advance chamber, and further comprises at least one check valve for blocking reverse fluid flow.

12. The phaser of claim 11, further comprising a passage connected to the pressurized fluid source for supplying makeup fluid to the advance chamber and the retard chamber.

13. The phaser of claim 12, wherein the passage further comprises a check valve.

14. (canceled)

15. (canceled)

16. A method of controlling the relative angular phase of a crankshaft and at least one camshaft in an internal combustion engine having an engine controller for producing an output signal indicative of a desired angular phase and a phaser coupled to the crankshaft and the at least one camshaft, and capable of adjusting the angular phase therebetween in response to the position of a phase control valve, comprising the steps of:
a) determining a desired angle between the camshaft and crankshaft based on engine parameters;
b) providing an output signal from the engine controller based on the desired position of the control valve to cause the phaser to move to a desired angular position;
c) sending the signal to a control pressure regulator valve from the controller to produce a regulated control pressure at an output port;
d) applying the regulated control pressure to the control valve in opposition to a spring force, such that a position of the phase control valve is changed to a determined position, causing the phaser to change the relative angular position of the camshaft and the crankshaft; and
e) when the desired angle is reached, performing steps (c) and (d) to return the control valve to a null position, holding the position in the desired angle.

17. (canceled)

18. The method of claim 16, wherein the control pressure regulator valve is remote from the phaser.

19. The method of claim 16, wherein the control pressure regulator valve is located in a cylinder head of the internal combustion engine.

20. The method of claim 16, wherein the control pressure regulator valve is located in a cam bearing cap of the camshaft.

21. (canceled)

22. (canceled)

23. The method of claim 16, wherein the phase control valve control phase position by routing fluid from a pressurized fluid source to an advance chamber or a retard chamber and routing fluid from the other of the retard chamber or advance chamber to an exhaust.

24. The method of claim 23, further comprising a check valve between the phase control valve and a pressurized fluid source.

25. The method of claim 16, wherein the phase control valve controls phaser position by selectively directing fluid from one of an advance chamber or a retard chamber to the other of the retard chamber or the advance chamber, and further comprises at least one check vale for blocking reverse fluid flow.

26. The method of claim 25, further comprising a passage connected to a pressurized fluid source for supplying makeup fluid to the advance chamber and the retard chamber.

27. The method of claim 26, wherein the passage further comprises a check valve.

28. (canceled)

29. (canceled)

30. (canceled)

31. The method of claim 16, in which: step a) and b) of comprises:
i) determining phase position between the camshaft and the crankshaft;
ii) summing the phase position and the set point, resulting in an error signal;
iii) inputting the error signal into a control law resulting in a control signal;
iv) summing the control signal and a null control signal; and
the signal in step b) comprises the sum of the control signal and the null control signal.

32. (canceled)

33. (canceled)

34. A rotary actuator for an internal combustion engine having at least one moving part and a stationary part comprising:
a housing with motion restricted to less than 360°;
a rotor for accepting drive force and connection to a shaft coaxially located within the housing, the housing and the rotor defining at least one chamber and at least one vane separating the chamber into an advance chamber and a retard chamber, the vane being capable of rotation to shift the relative angular position of the housing and the rotor;
a phase control valve for directing fluid flow to shift the relative angular position of the rotor relative to the housing, having a spool slidably received in a bore, wherein the spool is biased by a spring in a first direction; and
a regulated pressure control system comprising:
a controller for providing a signal based on engine parameters; and
a control pressure regulator valve having control input coupled to the controller, a supply port for receiving a supply fluid source pressure from a pressurized fluid source and a control port for supplying a regulated control pressure to the bore at an opposite end to the spring, for biasing the spool in a second direction opposite to the first direction;
wherein the supply port of the control pressure regulator valve receives a supply fluid source pressure from a pressurized fluid source and the control pressure regulator valve regulates the supply fluid source regulated control pressure based on the signal from the controller to a control pressure, which exits the control pressure regulator valve through the control port to bias the second end of the spool in a second direction, opposite the first direction, such that the relative angular position of the housing and the rotor spool in the bore is shifted.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. The phaser of claim 1, wherein the control pressure regulator is a variable bleed pressure regulator.

53. The phaser of claim 1, wherein the control pressure regulator is a direct acting variable force solenoid pressure regulator.
